(19) United States
(12) Patent Application Publication
(10) Pub. No.: US 2014/0246637 A1
(43) Pub. Date: Sep. 4, 2014

(54) DUAL WIND JACK

(71) Applicant: CEQUENT CONSUMER PRODUCTS, INC., Solon, OH (US)

(72) Inventor: Derek Anderson, Mayfield Heights, OH (US)

(73) Assignee: CEQUENT CONSUMER PRODUCTS, INC., Solon, OH (US)

(21) Appl. No.: 13/783,759

(22) Filed: Mar. 4, 2013

(51) Int. Cl. B60S 9/18; B66F 3/10; B60S 9/08

(52) U.S. Cl. CPC B60S 9/18; B60S 9/08; B66F 3/10
USPC 254/425; 254/124; 254/103

(57) ABSTRACT

An improved jack assembly includes multiple handle attachment positions. The jack assembly includes an outer tube and an inner tube moveable with respect to the outer tube. The outer tube includes a first handle attachment position to engage inner gearing and a second handle attachment position to engage inner gearing. A handle may be removably connected to the first attachment position or second attachment position. The outer tube may be connected to a mounting fixture and adjustable with respect to the mounting fixture.

### FIELD OF THE INVENTION

The present invention relates generally to jack assemblies and, more particularly, to improvements to trailer jack assemblies.

### BACKGROUND OF THE INVENTION

Cars, trucks, and sports utility vehicles are frequently used as towing vehicles to transport towed vehicles, such as trailers. Towed vehicles are typically supported by a frame that is attached to the towing vehicle. A portion of the frame extends beyond the body of the towed vehicle, toward the towing vehicle. This portion, called the tongue, is usually formed by connecting two pieces of the trailer frame at a predetermined angle. A frame coupler is usually attached to the tongue of the trailer. The frame coupler is sized and shaped to connect to a portion of the towing vehicle.

Jacks and jack assemblies have long been used with towing vehicles, such as trailers. Typically, a jack assembly is secured to a towing trailer and assists in stabilizing a towing trailer while the trailer is detached from a towing vehicle. For example, a jack may be mounted to the trailer tongue or directly to the frame coupler. Traditional frame couplers include a means for fixing the jack to the coupler. However, depending on the height of the trailer or jack being used, it may be advantageous to mount the jack at different heights relative to the frame. Further, depending on mounting position of the jack and the elevation of the ground where the trailer is parked, the height of the jack may require adjustment to engage the jack with the ground. Adjustment of the jack height however, may be obstructed by portions of the trailer or tower. Therefore, a jack assembly with configurable height adjustment control is needed in the art.

### SUMMARY OF THE INVENTION

The invention generally relates to a jack assembly for a towed vehicle. The jack assembly may include an outer tube and an inner tube moveable with respect to the outer tube. The jack assembly may include gearing to drive movement of the inner tube with respect to the outer tube.

The jack assembly may include a first handle attachment position in communication with the gearing and a second handle attachment position in communication with the gearing. Each handle attachment position may be configured to receive a handle or a handle assembly.

In an embodiment, the jack assembly may include a handle assembly removably connected to the outer tube. The handle assembly may be removable connected to a handle attachment position.

In an embodiment, the outer tube of the jack assembly may be adjustable with respect to a mounting fixture. The outer tube may include one or more holes, such as a protruding wall having one or more holes. The mounting fixture may include a channel to receive the protruding wall and a pin to selectively insert through one of the holes.

### DESCRIPTION OF THE DRAWINGS

Operation of the invention may be better understood by reference to the following detailed description taken in connection with the following illustrations, wherein:

FIG. 1 illustrates a perspective view of a jack assembly connected to a trailer.

FIG. 2 illustrates a jack assembly having a handle assembly attached to a side attachment position.

FIG. 3 illustrates a jack assembly having a handle assembly attached to a top attachment position.

FIG. 4 illustrates a cross-sectional view of a jack assembly.

FIG. 5 illustrates an exploded view of a wheel assembly connected to a jack assembly.

FIG. 6 illustrates a top view of a jack assembly.

FIG. 7 illustrates an exploded view of a handle assembly.

FIG. 8 illustrates an exploded view of an end cap and inner gearing of a jack assembly.

FIG. 9 illustrates a cross-sectional view of an inner gearing of a jack assembly.

FIG. 10 illustrates a perspective view of an outer tube.

FIG. 11 illustrates a top view of an outer tube.

FIG. 12 illustrates a back perspective view of a mounting fixture.

FIG. 13 illustrates a front perspective view of a mounting fixture.

FIG. 14 illustrates a top view of a mounting fixture.

FIG. 15 illustrate a perspective view of an embodiment of a mounting bracket.

FIG. 16 illustrates a perspective view of an embodiment of a mounting bracket.

FIG. 17 illustrates a top view of a mounting bracket connected to a mounting fixture.

### DETAILED DESCRIPTION

While the present invention is described with reference to embodiments described herein, it should be clear that the present invention should not be limited to such embodiments. Therefore, the description of the embodiments herein is only illustrative of the present invention and should not limit the scope of the invention as claimed.

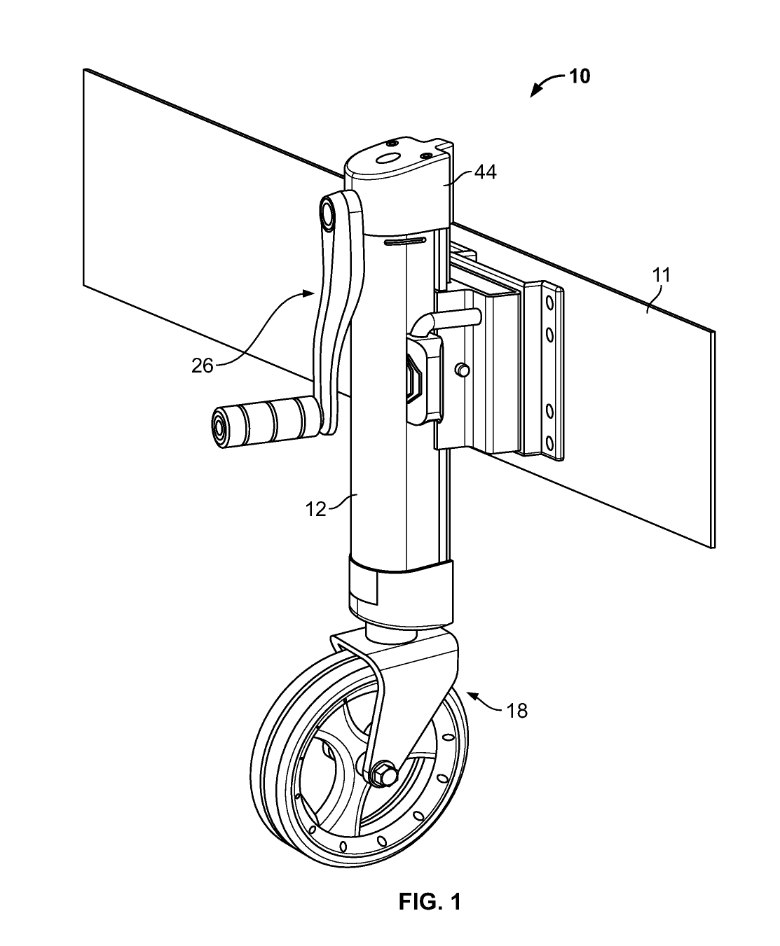

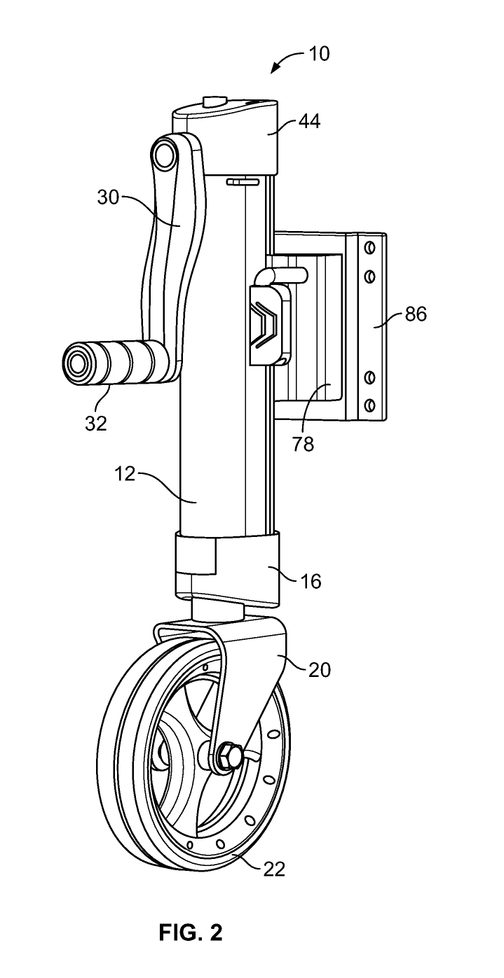

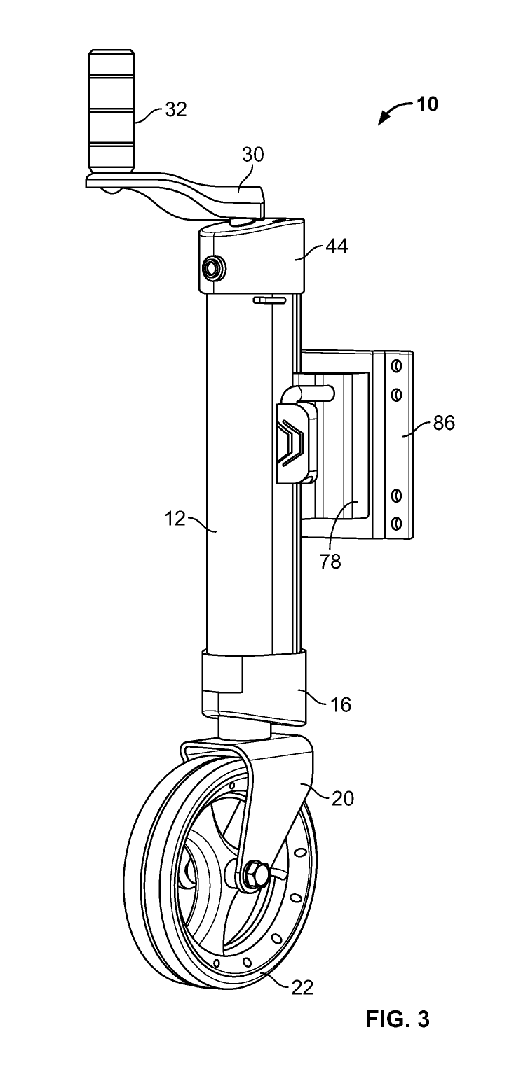

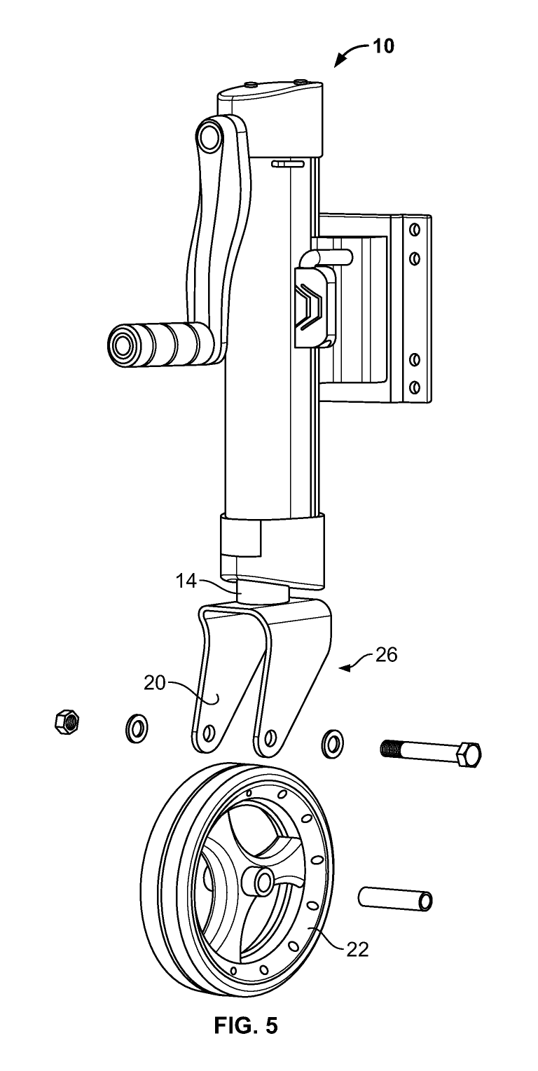

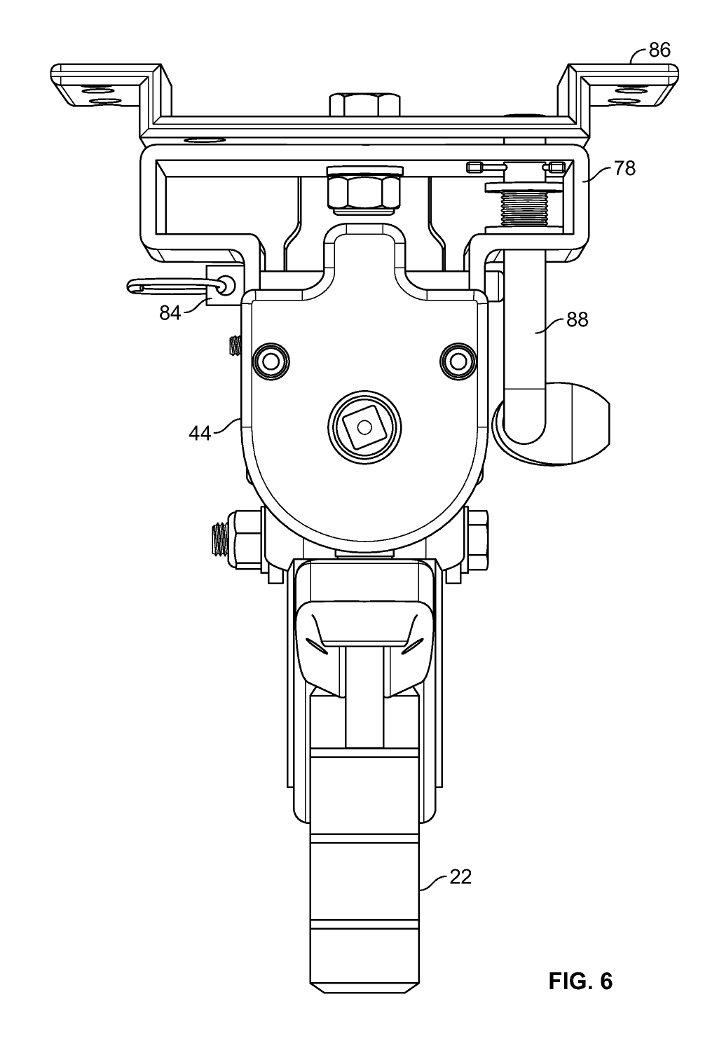

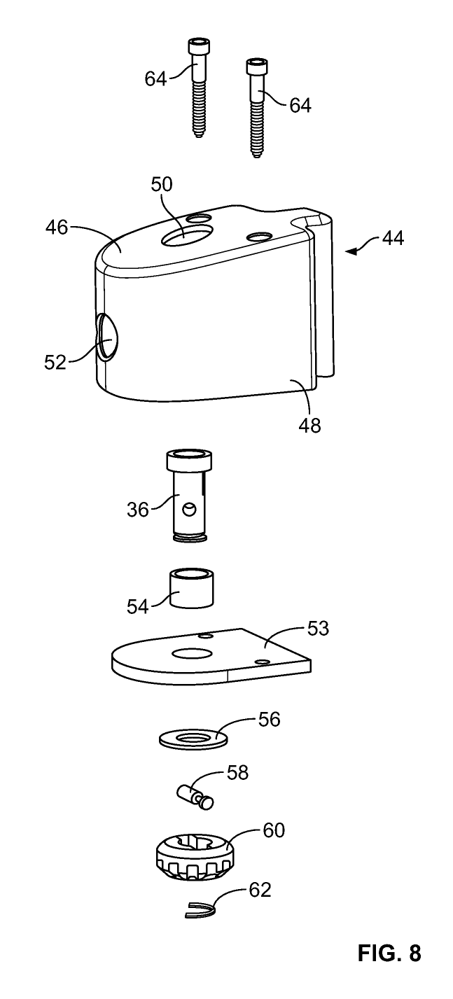

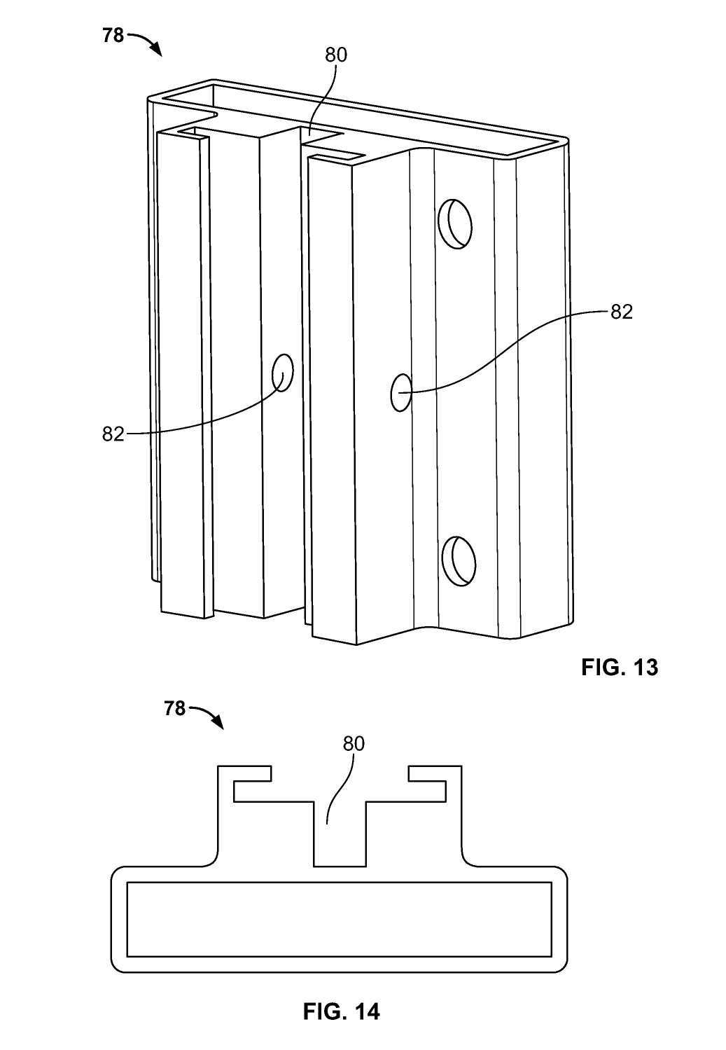

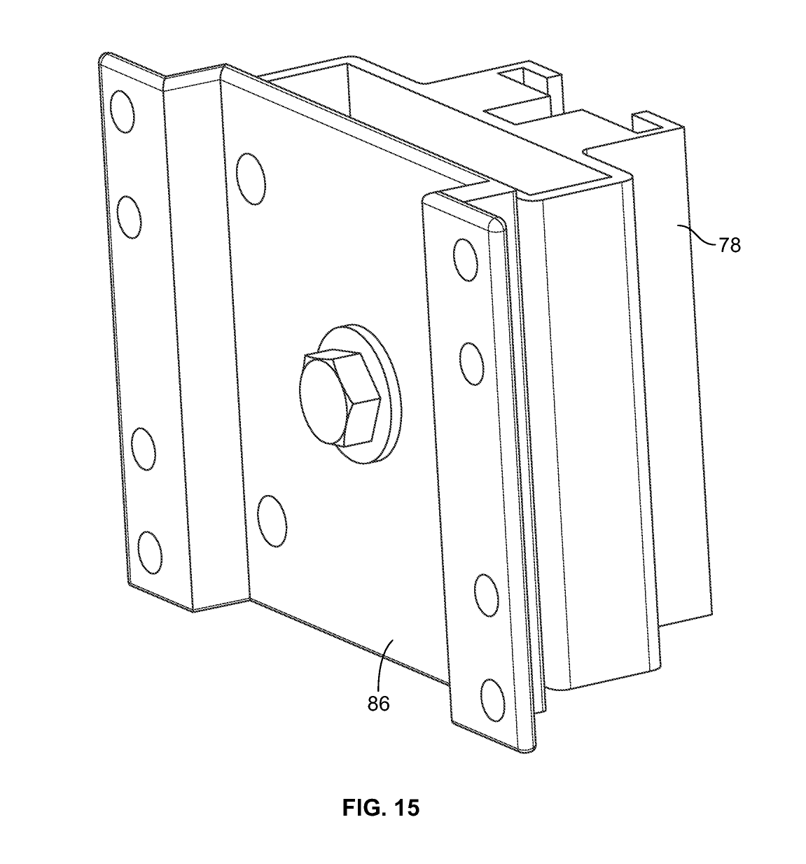

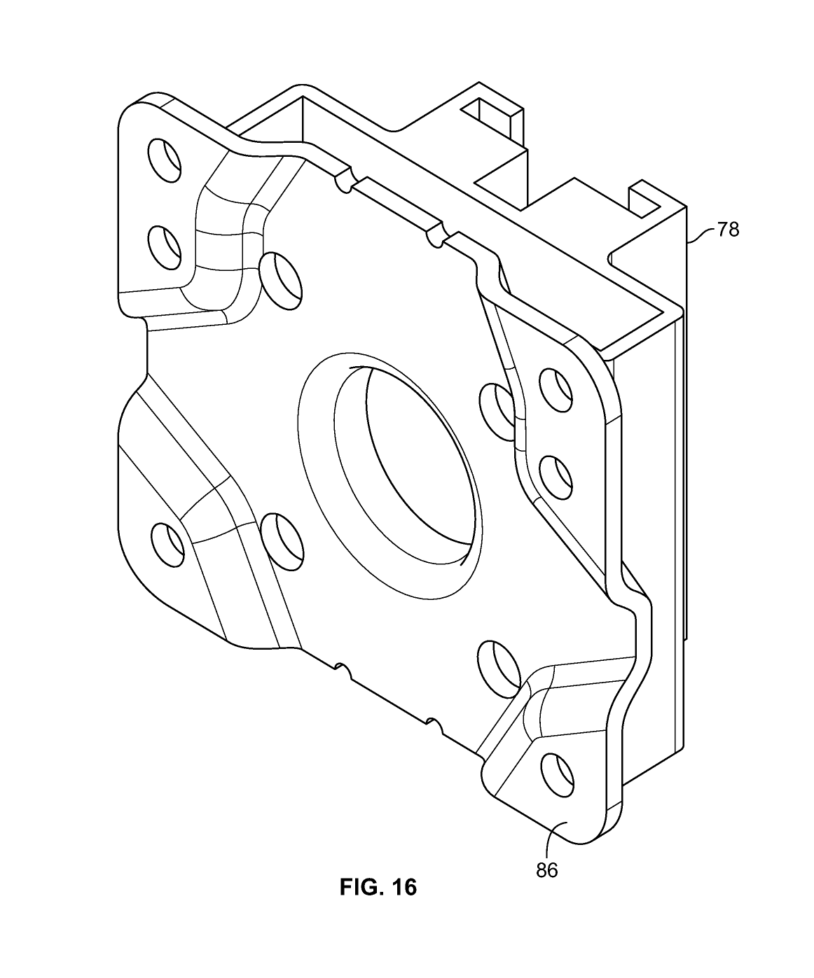

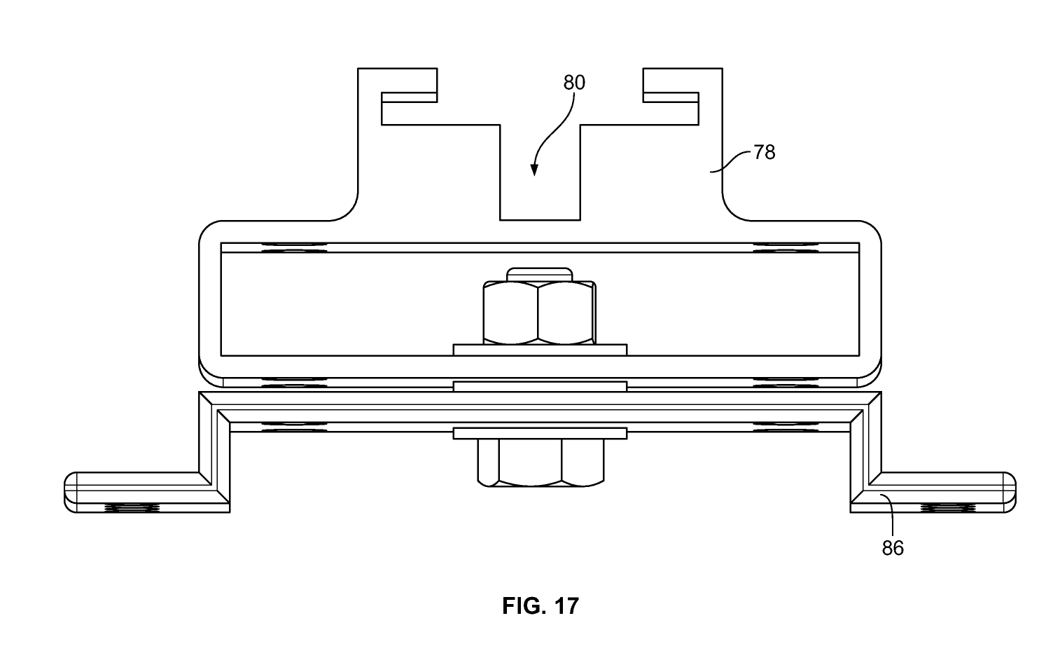

FIGS. 1 through 17 illustrate a jack 10 that includes a number of novel improvements over jack assemblies currently known in the art. The jack 10 may generally be configured to support a portion of a trailer 11 or other vehicle. For example, the jack 10 may be connected to a trailer. The jack assembly 10 may be connected to a tongue portion of the trailer to stabilize the trailer when it is parked. As further described below, the height of the jack 10 may be selectively adjusted to engage the ground or raise the jack as desired.

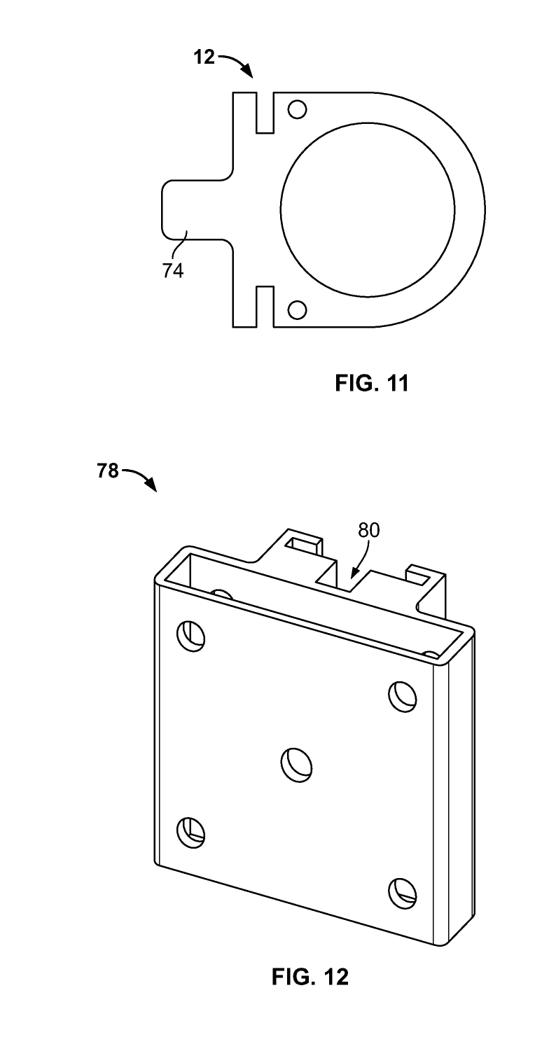

The jack 10 may include a body formed by an outer tube 12. The outer tube may be any appropriate size and shape and comprised of any appropriate material, such as aluminum, extruded aluminum, or steel. As illustrated in FIG. 11, the outer tube 12 may have a generally D-shaped cross-section having a first flat side extending to a rounded portion. The outer tube 12 may be hollow and may house components of the jack 10.

An inner tube 14 may be disposed within the outer tube 12 and configured to move with respect to the outer tube 12. The inner tube 14 may be any appropriate size and shape, such as generally cylindrical. The inner tube 14 may be sized and shaped to fit within the hollow opening of the outer tube 12 and move telescopically therein with respect to the outer tube 12. For example, the hollow opening of the outer tube 12 may be generally circular to receive a generally cylindrical inner tube 14. The inner tube 14 may extend past the outer tube 12 through an opening in the bottom of the outer tube 12. The inner tube 14 may be made of any appropriate material, such as alloy steel, and may be painted or surface treated, such as covered in a powder coating.

To facilitate relative movement of the outer tube 12 and inner tube 14, a bushing may be positioned between the tubes 12, 14. In one embodiment, an outer tube bushing may be secured to a lower end of the outer tube 12 such that a portion of the bushing is positioned between the tubes 12, 14 to prevent direct contact between the tubes 12, 14. In another embodiment, an inner tube bushing may be secured to an upper end of the inner tube 14 such that a portion of the bushing is positioned between the tubes 12, 14 to prevent direct contact between the tubes 12, 14. It will be appreciated by those skilled in the art that a bushing may be secured to either end of the inner tube 14 to prevent direct contact of the tubes 12, 14. Alternatively, the jack 10 may have no bushings and employ alternative devices, such as locating plates and end caps, to separate the outer tube 12 and the inner tube 14.

A bottom cap 16 may be disposed about a bottom end of the outer tube 12. The bottom cap 16 may cover the bottom portion of the outer tube 12. The bottom cap 16 may include an opening to allow the inner tube 14 to extend therethrough. The bottom cap 16 may be any appropriate material, such as plastic.

The jack 10 includes a wheel caster assembly 18. The caster assembly 18 may be positioned at the base of the jack 10 and may be configured to selectively engage the ground. The caster assembly 18 may include a wheel base 20 and a wheel 22. It will be appreciated that the wheel assembly 18 may include more than one wheel 22 as necessary. The wheel base 20 may connect to a portion of the inner tube 14, such as an end portion of the inner tube 14. The wheel base 20 may support the wheel 22 and allow the wheel 22 to rotate with respect to the wheel base 20. The wheel 22 may be any appropriate size and shape. In an embodiment, the wheel 22 is approximately eight-inches in diameter. The wheel 22 may be plastic, rubber, or any other appropriate material. The wheel assembly 18 may further include a brake 24. The brake 24 may be movable with respect to the wheel base 20 to engage the wheel 22 and prevent rotation of the wheel 22.

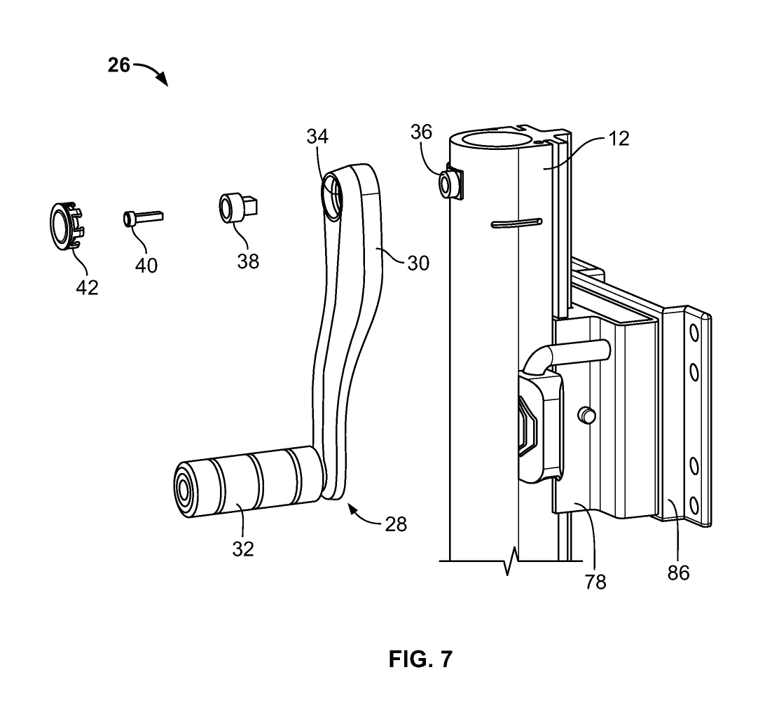

The jack 10 includes a handle assembly 26, as shown in the exploded view in FIG. 7. The handle assembly 26 may be generally configured to engage the inner gearings of the jack 10 to selectively and operably raise and lower the jack 10.

The handle assembly 26 may include a crank 28. The crank 28 may be any appropriate size and shape, such as generally L-shaped. For example, the crank 28 may include a shaft 30 and a grip 32, such as a rubber grip, extending from the shaft 30.

The crank 28 may be secured to the jack 10 and rotatable with respect to the outer tube 12. For example, the shaft 30 may include an opening 34. The opening 34 may engage a gear shaft 36 of the jack 10. For example, as illustrated in FIG. 7, a portion of the gear shaft 36 may extend beyond the perimeter of the outer tube 12. The opening 34 may be aligned with a hole in the gear shaft 36 and an adapter 38 may be inserted through the opening 34 and into the gear shaft 36. The adapter 38 may be configured to connect to the gear shaft 36 and receive a screw 40 therein. The screw 40 may be inserted into the adapter to secure the handle shaft 30 to the gear shaft 36. A cap 42, such as a plastic cap, may be placed over the opening 34 to protect the screw 40.

An end cap 44 may be connected to the top end of the outer tube 12. The end cap 44 may be sized and shaped to fit the shape of the outer tube 12. For example, the end cap 44 may include a top portion 46 configured to cover the opening of the outer tube 12 and a skirt 48 extending down from the top portion 46 and fitted along the side of the outer tube 12. The end cap 44 may be made of any appropriate material, such as plastic. The end cap 44 may include various openings, such as opening to receive mounting screws 64. The end cap 44 may further include a first hole 50 on the top portion 46 to provide access to a top gear shaft 36, and a second hole or slot 52 in the skirt 48 to provide access to a side gear shaft 36. As further described below, the first and second holes 50, 52 may allow for various connection positions of the handle assembly.

The jack 10 may be generally configured to allow the handle assembly to be attached at more than one location on the jack 10. For example, as described above, the handle assembly 26 may connect to the gear shaft 36 to allow the crank 28 to rotate the gear shaft 36 and selectively and operably raise and lower the jack 10. The handle assembly 26, however, may be removably connected to the jack 10 and connectable at more than one location. For example, the handle assembly 26 may be removed from a first position on the jack 10 by removing the cap 42, unscrewing the screw 40, and removing the adapter 38 and crank 28 from the gear shaft 36. The handle assembly 26 may then be reattached to the jack 10 at a second position to engage the gear shaft 36.

To allow for selective placement of the handle assembly 26, the jack 10 may include more than one attachment positions. For example, the jack 10 may include a first attachment position on the top of the jack 10 and a second attachment position on the side of the jack 10. It will be appreciated, however, that the jack 10 may include any number of attachment positions. Each attachment position may include access to a gear shaft 36 that drives movement of the jack 10. The handle assembly may be selectively coupled to the gear shaft 36 as described above, or by any appropriate means.

The end cap 44, as described above, may include a first hole 50 and second hole 52 to allow for attachment positions. For example, the first hole 50 and second hole 52 may each provide an opening to allow access to a gear shaft 36. The first hole 50 may allow the handle assembly 26 to be connected to the top of the jack 10 to avoid obstacles that may hinder motion of the handle on the side of the jack 10. The second hole 52 may allow the handle assembly 26 to be connected to the side of the jack 10 to avoid obstacles that may hinder motion of the handle on the top of the jack 10.

In an embodiment, the top portion 46 may include an attachment position to engage the gear shaft 36. A locator plate 53 having a hole therein may be positioned within the end cap 44 and aligned with the hole 50. A bushing 54 may be aligned with the hole in the locator plate 53. A top gear shaft 36 may be inserted through the bushing 54 and through the hole 50. A washer 56 may be placed on the gear shaft 36 on the underside of the locator plate 53, and a pin 58 may be inserted through a hole in the gear shaft 36 to retain the gear shaft 36 within the hole 50. A top bevel gear 60 may be slid onto the gear shaft 36. The top bevel gear 60 may be configured to engage other gearing of the jack 10, as further described below. The top bevel gear 60 may be fixed to the gear shaft 36 by a retaining ring 62 or other retaining feature to allow the top bevel gear 60 to rotate with the shaft 36. The locator plate 53 and end cap 44 may be fixed to the outer tube 12 by mounting screws 64. A portion of the gear shaft 36 may protrude through the hole 50 in the top portion 46 of the end cap 44 or otherwise be accessible to the exterior of the jack 10. The handle assembly 26 may then be attached to the top attachment point as descried above.

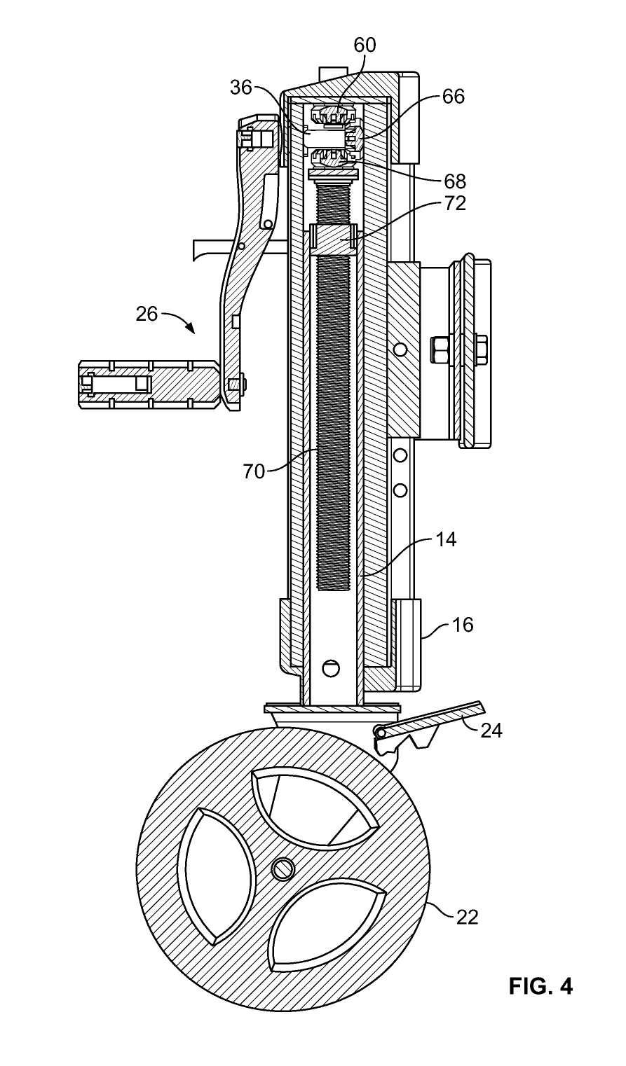

The jack 10 may further include a side attachment position, as shown in FIG. 4. The side attachment point may be similar to the top attachment point, as described above. The second hole 52 in the skirt 48 of the end cap 44 may provide access to a side gear shaft 36. The side gear shaft 36 may protrude through the skirt 48 and through the outer tube 12 to engage a side bevel gear 66. The handle assembly 26 may be connected to the side gear shaft 36 to allow the crank 28 to rotate the side gear shaft 36 and selectively raise and lower the jack 10.

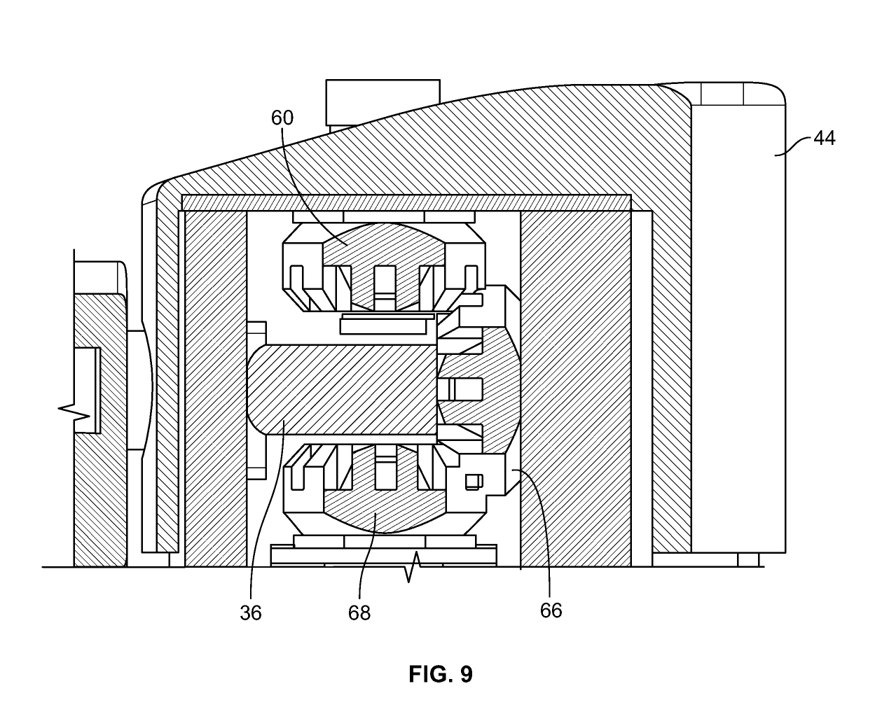

The jack 10 may include internal gearing necessary to provide multiple attachment points for the handle assembly 26. For example, as described above, the jack 10 may include a top bevel gear 60 to engage a top gear shaft 36 for a top attachment point, and a side bevel gear 66 to engage a side gear shaft 36 to provide a side attachment point. With reference to FIGS. 4 and 9, the top and side bevel gears 60, 66 may be engaged to rotate together. For example, the top and side bevel gears 60, 66 may be arranged perpendicular to each other such that the teeth of the top bevel gear 60 engage the teeth of the side bevel gear 66. Thus, rotation of one gear will move the other.

The jack may further include a bottom bevel gear 68. The bottom bevel gear 68 may be arranged to engage the side bevel gear 66 and rotate therewith. As shown in FIGS. 4 and 9, this arrangement will allow rotation of either the top bevel gear 60 or the side bevel gear 66 to rotate the bottom bevel gear 68. While the jack 10 is illustrated as including three bevel gears, it will be appreciated that the jack 10 may include any number of gears or other components to provide the desired number of attachment points and facilitate movement of the jack 10.

The bottom bevel gear 68 may be connected to a screw 70 that extends within the hollow body of the inner tube 14. The screw 70 may extend through and engage a nut 72 that is connected and fixed to a portion of the inner tube 14. Rotation of the screw 70 may drive the nut and inner tube 14 up or down with respect to the outer tube 12, thus raising or lowering the wheel assembly 18.

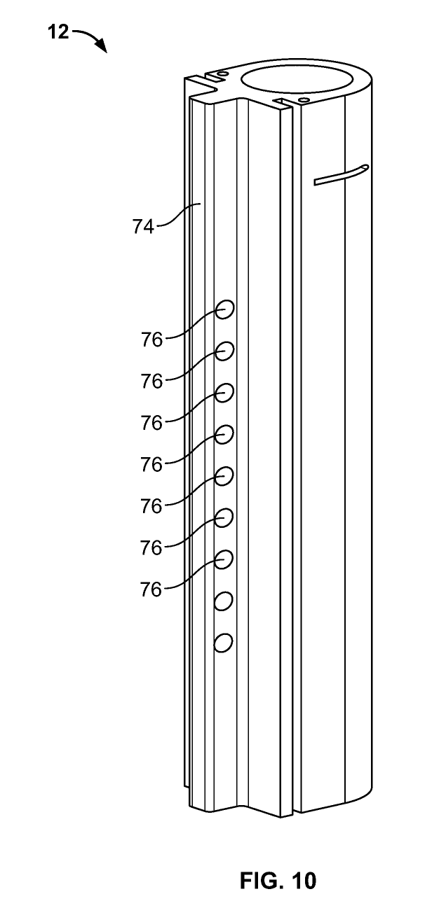

The outer tube 12 may be configured to provide height adjustment with respect to a mounting device. As shown in FIGS. 10 and 11, the outer tube 12 may include a protruding wall 74. The protruding wall 74 may extend from a portion of the outer tube 12, such as a flat wall portion, as shown in FIGS. 10 and 11. The protruding wall 74 may extend along the entire length of the outer tube 12 or along only a portion of the tube 12.

The protruding wall 74 may include a sliding track having a plurality of holes 76. The holes 76 may be any appropriate size and shape and may be spaced apart any appropriate distance. The holes 76 may extend through a portion of the protruding wall 68 or completely through the protruding wall 74, and may be configured to receive a pin or retaining device therein.

The protruding wall 74 may be generally configured to engage a mounting fixture 78, as shown in FIGS. 12-14. The mounting fixture 78 may be any appropriate size and shape, just as generally square. The mounting fixture may include a channel 80 sized and shaped to receive the protruding wall 74. The channel 80 may comprise an opening similarly shaped to the protruding wall 74 to allow the protruding wall 74 to slide therein. The channel 80 may include one or more connecting holes 82. The connecting holes 82 may be sized and shaped similar to the holes 76 in the protruding wall 74 and may be configured to receive a pin 84 or retaining device therein. In an embodiment, the channel 80 may include two connecting holes 82 with one hole 82 positioned on each side of the channel 80. The connecting holes 82 may be aligned to allow a pin 84 to be inserted through a first connecting hole 82, through a hole 76 in the protruding wall 74, and through the second connecting hole 82.

The mounting fixture 78 may provide selective height adjustment for the jack 10. For example, the height of the jack 10 may be selected by adjusting the outer tube 12 with respect to the mounting fixture 78 to the desired height and aligning the closest hole 76 in the protruding wall 74 with the connecting holes 82, then inserting a pin 84 through the connecting holes 82. This feature may provide a wide range of height adjustment in addition to the height adjustment provided by the screw 70.

The mounting fixture 78 may be connectable to a mounting bracket 86. For example, the mounting fixture 78 may be screwed or bolted to a mounting bracket 86, as shown in FIG. 17. In an embodiment, the mounting bracket 86 may include a single bolt connection to allow the mounting fixture 78 to rotate with respect to the mounting bracket 86. The mounting fixture 78 and mounting bracket 86 may each include a plurality of holes to receive a pin 88 therein. The mounting fixture 78 may be rotated to the desired orientation to move the jack 10 to a horizontal position, away from contact with the ground. The pin 88 may be inserted through the aligned holes in the mounting fixture 78 and mounting bracket 86 to hold the fixture 78 in place. The mounting bracket 84 may include a plurality of mounting holes to attach the jack 10 to any desired surface, such as a trailer.

The invention has been described above and modifications and alterations will occur to others upon a reading and understanding of this specification. The claims as follows are intended to include all modifications and alterations insofar as they come within the scope of the claims or the equivalent thereof.

Having thus described the invention, we claim:

1. A jack assembly comprising:
an outer tube;
an inner tube positioned within said outer tube and movable with respect to said outer tube;
a gearing configured to drive movement said inner tube with respect to said outer tube;
a first handle attachment position configured to receive a handle to engage said gearing; and
a second handle attachment position configured to receive a handle to engage said gearing.

2. The jack assembly of claim 1 further comprising a handle assembly configured to connect to said first handle attachment position or said second handle attachment position.

3. The jack assembly of claim 1, wherein said first handle attachment position is located on the top of said outer tube and wherein said second handle attachment position is located on a side of said outer tube.

4. The jack assembly of claim 1 further comprising an end cap connected to an end of said outer tube.

5. The jack assembly of claim 1 further comprising a first hole and a second hole in said end cap to provide access to said first handle attachment position and said second handle attachment position.

6. The jack assembly of claim 1 further comprising a wheel assembly attached to an end of said inner tube.

7. A jack assembly comprising:
an outer tube;
an inner tube positioned within said outer tube and moveable with respect to said outer tube;
a gearing configured to drive movement of said inner tube with respect to said outer tube;
a first attachment position located on said outer tube;
a second attachment position located on said outer tube; and
a handle assembly removably and operably attached to one of said first attachment position and said second attachment position, wherein said handle assembly is configure to engage said gearing.

8. The jack assembly of claim 7, wherein said handle assembly comprises a crank having an opening therein, an adapter configured to engage said opening and engage said gearing.

9. The jack assembly of claim 7, wherein said gearing includes a first gear shaft configured to engage a handle assembly at said first attachment position and a second gear shaft configured to engage a handle assembly at said second attachment position.

10. The jack assembly of claim 9, wherein said gearing includes a first bevel gear in communication with said first gear shaft and a second bevel gear in communication with said second gear shaft.

11. The jack assembly of claim 10, wherein said first bevel gear is configured to engage said second bevel gear.

12. The jack assembly of claim 10 further comprising a screw configured to drive movement of said inner tube with respect to said outer tube, wherein rotation of said first bevel gear or said second bevel gear is configured to drive rotation of said screw.

13. The jack assembly of claim 12 further comprising a third bevel gear connected to said screw and in communication with said second bevel gear.

14. The jack assembly of claim 7 further comprising a wheel assembly connected to said inner tube.

15. A jack assembly comprising:
an outer tube having a plurality of holes therein;
an inner tube positioned within said outer tube and moveable with respect to said outer tube;
a gearing configured to drive movement of said inner tube with respect to said outer tube;
a mounting fixture connected to said outer tube, said mounting fixture including a pin to engage any one of said holes in said outer tube; and
wherein the height of said outer tube is adjustable with respect to said mounting fixture.

16. The jack assembly of claim 15, wherein said holes are located on a protruding wall of said outer tube.

17. The jack assembly of claim 16, wherein said mounting fixture includes a channel to receive said protruding wall.

18. The jack assembly of claim 17, wherein said channel includes a hole therethrough to receive said pin through said channel and through one of said holes in said protruding wall.

19. The jack assembly of claim 15 further comprising a mounting bracket connected to said mounting fixture, wherein said mounting fixture is rotatable with respect to said mounting bracket.

20. The jack assembly of claim 19, wherein said mounting bracket is connected to a trailer.
